(19) United States
(12) Patent Application Publication
(10) Pub. No.: US 2019/0244551 A1
(43) Pub. Date: Aug. 8, 2019

(54) SIGN UTILIZING FLEXIBLE LED TUBE SECURED BY UNIQUE ELEMENTS AND METHOD OF CREATION/USE

(71) Applicant: John Chiang, Carlsbad, CA (US)

(72) Inventor: John Chiang, Carlsbad, CA (US)

(21) Appl. No.: 16/040,316

(22) Filed: Jul. 19, 2018

Related U.S. Application Data
(60) Provisional application No. 62/627,997, filed on Feb. 8, 2018.

(51) Int. Cl. G09F 13/04; G09F 13/08; G09F 13/22; F21V 19/00

(52) U.S. Cl. CPC G09F 13/0404; G09F 13/08; F21V 19/003; G09F 13/22; G09F 13/0413

(57) ABSTRACT

This disclosure describes an LED sign that has the exterior appearance of a neon sign, but is much easier and less expensive to mass produce, and has none of the environmentally challenging elements of a neon sign. The sign has a frame that mounts to a background element, through which one or more channels are routed or molded. Flexible LED light tubes are laid into the channels and then closed off with heat shrink tubes. Because the LED light tubes are restrained in the channel, the sign takes on the desired shape that has been formed into the background, allowing the sign to be mass-produced economically for even small quantities, as there is no need for an expensive mold. The background can be 1-piece, or made from multiple pieces connected to each other in a removable fashion.

### CROSS-REFERENCES TO RELATED APPLICATIONS

The present application is a non-provisional patent application claiming priority under 35 U.S.C. § 119(e) to U.S. Provisional Patent Application No. 62/627,997, filed Feb. 8, 2018, the entire contents of which are incorporated by reference as if set forth fully herein.

### FIELD

The present disclosure relates generally to advertising signs, and more specifically to an advertising sign that utilizes one or more flexible LED light tubes to spell out a name or created a logo, where the LED light tubes are embedded in a backing that has been routed in a specific shape to create the desired art.

### BACKGROUND

Illuminated signs have long been a means by which a store, bar, or other commercial establishment advertises to the public everything from what they sell to whether they are open or closed. In the past, these signs were traditionally made using neon tubes. While neon tubes have been a mainstay of the American restaurant and bar industries, among others, for nearly 100 years, they are far from a perfect product.

Among the problems inherent in the creation and use of neon signs is the difficulty and expense of creating a neon sign in a particular desired shape. To make a single neon element (and some signs have many different elements), a glass bender bends glass tubing into the desired shape. Many neon signs are bent into shape using a combination of ribbon burners, cannon burners and crossfires, each of which impart to the glass tube a different shape. The creation process may also include the addition of one or more phosphorous layers, or even the butt-welding of different sections of glass tubing together to create different colors. Color creation also usually involves the addition of some combination of pure neon gas, argon gas, and even mercury. The neon tube can then be ionized by electrification, which vaporizes the mercury, creating mercury vapor.

The tube is “sealed” by melting or welding a cold cathode electrode to each open end of the tube. The electrodes are hollow and often contain lead glass from which two wires protrude for wiring into a signal or directly into A/C current. The tube is then evacuated of most of its air, to create a “vacuum tube”, and high current and voltage is then “bombarded” through the low-pressure air in the tube to make sure that the electrodes are heated sufficiently without damaging the glass tube. Several other procedures are done before the interior of the neon tube is “clean enough” for the final filling. In this final filling, one or more of neon, argon, krypton, xenon, and helium is used as the gas, often with a drop of mercury. The final neon tube is then assembled with other neon tubes on a rack to create the desired display, and the various electrical leads are hooked up to create the final sign.

In addition to the time it takes to create a neon sign, the gasses and other compounds used to create neon signs—particularly mercury—present health and environmental concerns. Indeed, the Environmental Protection Agency has specific guidelines for the disposal of damaged or no-longer-needed neon signs. In addition, some cities in the United States and abroad, and even some foreign governments have banned some or all neon signs because of their mercury content and/or high-energy usage.

Because of these problems, many sign manufacturers (and purchasers of their products) prefer to use light-emitting diodes (LED) rather than neon. The initial attempts at LED sign manufacturing involved placing individual LEDs in a particular pattern and covering them with a colored, light-transmitting sheet to create the appearance of a colored neon sign. This obviously took a considerable amount of effort as the individual LEDs had to be placed in a certain pattern, connected to electrical current, and then covered to mimic the appearance of a neon light.

One example of this technology can be found in U.S. Pat. No. 7,721,475 to Chiang, which teaches a sign panel with LEDs that are turned into, as the title of the patent implies, a “simulated neon illuminating sign” where some portions are blacked out, and other portions are highlighted in certain colors. While this patent avoids the environmental problems associated with mercury and the amount of time taken to create neon tubes, it is still time-intensive, as can be seen in FIG. 5, reference number 91. Moreover, the resulting simulated neon sign is not visually convincing as a neon sign simulate (e.g. does not have the skeletal appearance of a true neon sign).

Following the emergence of strips of LEDs electronically connected to each other, some manufacturers began securing these LED strips into particular patterns with the goal of decreasing the time it took to create the final product. An example of a more recent attempt to retain the benefits of neon without environmental concerns while decreasing the amount of time it takes for a craftsperson to create the sign can be found in US Publication No. 2017/278,438 to Enhance Neon Technologies. Again, as the name of the Assignee/Inventor and the title of the invention—“Simulating neon lamp”—implies, the goal was to mimic the appearance of a neon sign but avoid the environmental and time constraints of neon. In this invention, a light strip has been mounted to a PCB substrate and/or sandwiched in between a number of other layers to create the final sign. A very similar technology can be found in WO 2011/025,489 to Kaoh, which also provides a sandwich assembly utilizing more than two light strips attached in a coordinated manner.

A further disadvantage with the prior art is that in making their multi-layer lighting devices, the manufacturers rely on at least one injection-molded piece. The cost of a single mold from which these templates are made can easily cost $25,000 or more. This cost has to be passed on to the purchaser of the sign, so for a company wishing to purchase only a small quantity of signs (e.g. 500 or less), the “share” of the mold price for each sign can be prohibitively high. This results in many businesses not ordering the signs that they want, and many manufacturers not getting the business from making the signs.

### SUMMARY

While the prior art cited above succeeds in incorporating light strips—as opposed to individually fixing a series of LED lights—into a sign, there is little guidance as to how to secure the light strip in a particular shape other than to sandwich it in between multiple layers that then secure it in the desired orientation. There is also no guidance on how to make the LEDs mimic the appearance of neon other than to put additional sandwich layers over them. Thus, it is desirable to provide a lighted sign where a light strip can be easily manipulated into and retained in a desired shape, and where the light strip itself can provide a neon look without the need for additional layers.

The current disclosure provides a solution to the expensive injection-molding problem by providing a three-part sign that includes a frame upon which a background is attached, where the background has one or more routed recesses or channels into which a flexible LED light tube is placed. Because the recesses are molded or routed in the desired shape, there is no need to bend, twist, or otherwise secure the light tube(s) into any shape prior to final assembly of the lighted sign, as all the user needs to do is lay a flexible light tube into a channel.

The lighted sign described herein by way of example includes a frame, background, and one or more flexible LED light tubes (or strips, ropes, etc.). The frame attaches to a wall or other structure and holds the background in place. The frame is preferably constructed using a strong, resilient substance (or a combination of two or more strong, resilient substances) capable of maintaining a secure attachment to a wall or other structure while also securely holding the background in place, for example such as metal, plastic, and/or wood. A particularly preferred embodiment calls for a frame made from a black, powdered coated metal. The background is attached to the front of the frame. The background is essentially a “container” that has two high sides and a central recess (also “valley” or “channel”) into which an LED light tube is placed. The background may have any shape desired, however in most cases the shape of the background will be roughly the shape of the desired end product. The background may be created through molding, routing, or any other process that includes formation of one or more recesses therein. A flexible LED light tube is then inserted and secured into the recess(es) and attached to a power source. The LED light tube may be optionally covered to further secure it in place. When powered on, the LED light tube creates a bright, attractive display that is very similar to a neon light display, but with easier creation of the work of art, less power consumption, and without the use of toxic chemicals and dangerous materials.

It is therefore an object of the present disclosure to provide a lighted sign that has all the benefits of a neon sign and yet can be easily mass-produced in an assembly line manner. An additional object of the disclosure includes providing a three-part sign that is inexpensive to produce and easy to assemble and mount. A further object of the disclosure is to provide a recessed background piece including one or more recesses where the recesses are molded or routed in a desired shape, such that a flexible light tube can be laid in each recess to create a desired lighted artwork or sign.

The lighted sign and method described herein by way of example is advantageous over prior art examples for a number of reasons. For example, the lighted sign of the present disclosure is a simpler product with fewer pieces and easier assembly relative to prior art LED and/or neon signs. As a result, the lighted sign of the present disclosure is less expensive to produce.

The lighted sign of the present disclosure mimics a neon sign but without the time-consuming construction and use of environmentally dangerous materials, and the resulting product is significantly stronger than a neon tube.

The lighted sign of the present disclosure may be created without relying on either hand-bending or thermal/injection forming, thereby allowing for improved economics when a sign maker secures an order for small quantities and creating a mold for that particular sign would be cost-prohibitive for a small order.

The lighted sign of the present disclosure has a true neon look but relies solely on LEDs, complete with a metal frame that looks like a vintage neon sign, and rounded LED light tubes that resemble neon tubes.

The lighted sign of the present disclosure produces a quality neon look but without the use of single LED lights, LED strips, and/or LED boards underneath in an enclosed cavity, and without the large number of “sandwich layers” found in much of the prior art, thereby avoiding an excessively large number of circuits which, in turn, creates a significantly larger risk of a defect in a single circuit shutting down all or part of a sign.

The lighted sign of the present disclosure has an external appearance similar to a true neon sign. The use of LED tubes in a recess allows the top of the LED tube to protrude slightly and display a rounded exterior, very similar to that of true neon tubes. Alternatively, a protective/artistic curved cover can be installed over the LED tube to provide a different look and feel to the sign. In either case, the lighted sign of the present disclosure gives a more artistic, “handmade” appearance to a sign that, in fact, was mass-produced at a significantly lower cost than was possible using prior art methods.

The lighted sign of the present disclosure uses precision laser cutting/CNC machining to create a sign with a minimal amount of material around the actual light tube.

There has thus been outlined, rather broadly, the more important features of the lighted sign of the present disclosure in order that the detailed description thereof may be better understood, and in order that the present contribution to the art may be better appreciated. There are additional features that will be described hereinafter and which will form the subject matter of the claims appended hereto. The features listed herein and other features, aspects and advantages of the present disclosure will become better understood with reference to the following description and appended claims.

### BRIEF DESCRIPTION OF THE DRAWINGS

Many advantages of the present disclosure will be apparent to those skilled in the art with a reading of this specification in conjunction with the attached drawings, wherein like reference numerals are applied to like elements and wherein:

FIG. 1 is a front plan view of an example of a lighted sign according to one embodiment of the present disclosure;

FIG. 2 is a side plan view of the lighted sign of FIG. 1;

FIG. 3 is an exploded perspective view of the lighted sign of FIG. 1; and

FIGS. 4-8 are perspective, sectional views of a portion of the lighted sign of FIG. 1, illustrating an example of a terminal section according to several embodiments.

### DETAILED DESCRIPTION OF A PREFERRED EMBODIMENT

Illustrative embodiments of the disclosure are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. The lighted sign and related methods disclosed herein boast a variety of inventive features and components that warrant patent protection, both individually and in combination.

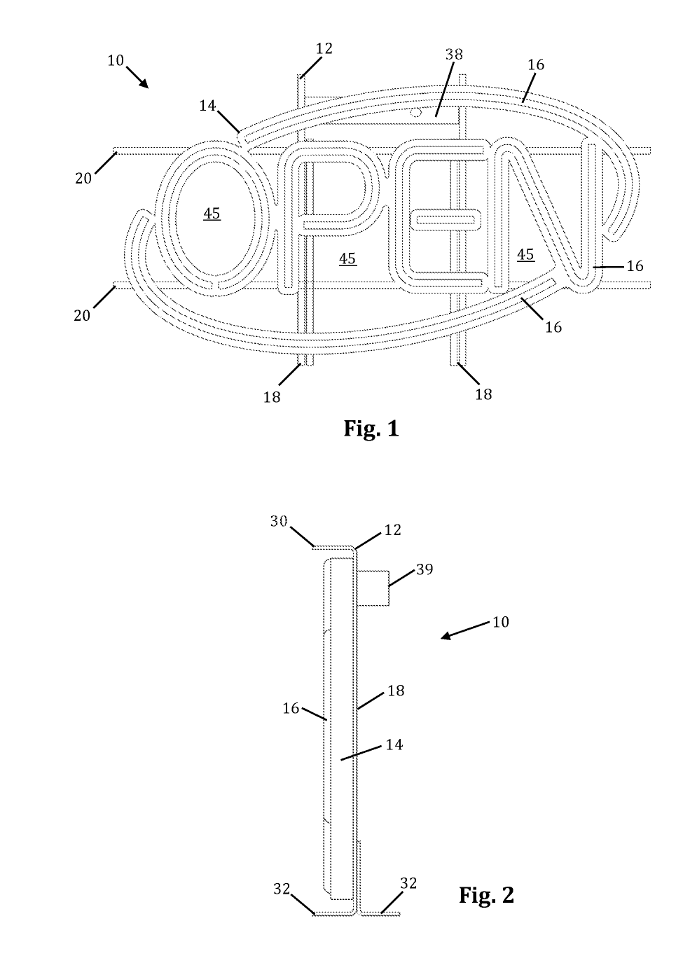

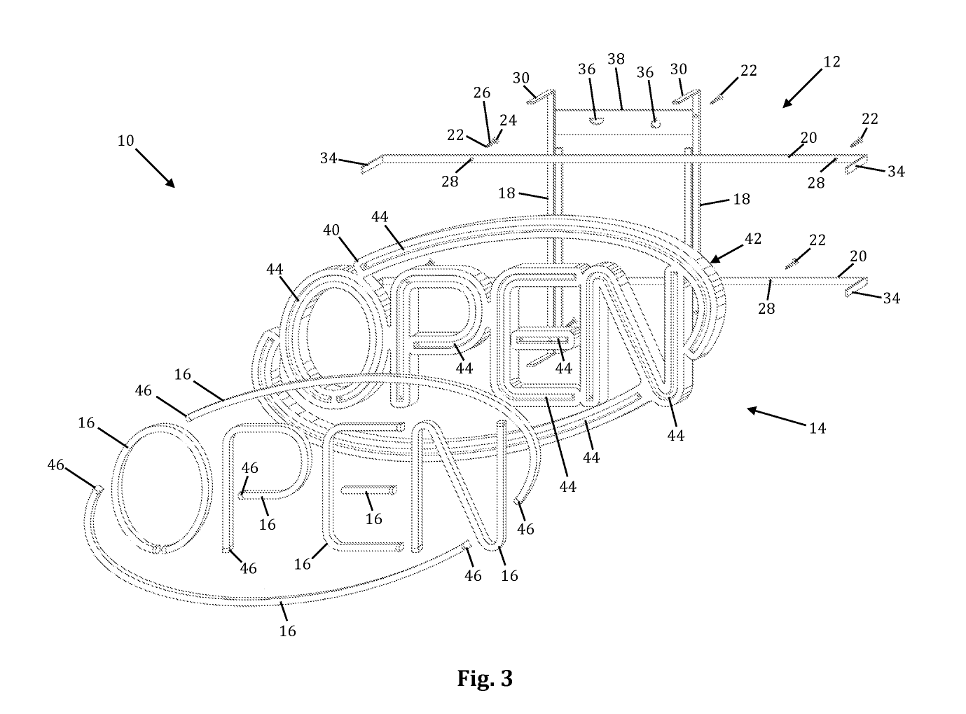

FIGS. 1-3 illustrate an example of a lighted sign 10 according to one embodiment of the present disclosure. By way of example only, the lighted sign 10 described herein includes a frame 12, background 14, and at least one flexible LED light tube 16. Generally, the frame 12 attaches to a wall or other structure, and holds the background in place. The background 14 is essentially a “container” that has two high sides and a central recess (also “valley” or “channel”) into which one ore more LED light tubes 16 are placed. The LED light tube(s) may be optionally covered to further secure it in place. When powered on, the LED light tube 16 creates a bright, attractive display that is very similar to a neon light display, but with easier creation of the work of art, less power consumption, and without the use of toxic chemicals and dangerous materials.

The frame 12 is configured to enable attachment of the background 14 to a structure upon which the lighted sign 10 is displayed, for example a wall, signpost, rooftop, shelf/ledge, and the like. As such, the frame 12 comprises a background support component, a background engagement component, and a structure engagement component. The frame 12 (and each of its components) is preferably constructed using one or more strong, resilient, rigid or semi-rigid material(s) capable that can either be molded or bent into a desired final shape, for example such as a metal, plastic, and/or wood. A particularly preferred embodiment calls for a frame made from a black, powdered coated metal.

By way of example only, the background support component of the frame 12 comprises a combination of vertical supports 18 and horizontal supports 20. The combination includes at least one vertical support 18 and at least one horizontal support 20, however the number and arrangement of each may vary depending upon the size and shape of the background to be supported. For instance, the frame 12 of the lighted sign 10 shown by way of example in FIGS. 1-3 includes a pair or vertical supports 18 and a pair of horizontal supports 20 arranged in a crosshatch orientation.

The background engagement component of the frame 12 comprises any means or mechanism capable of securing the background to the frame, including but not limited to screws, bolts, nails, adhesives, clips, and the like. By way of example, the background 14 of the instant embodiment is secured to the frame 12 by a plurality of fasteners 22 (e.g. screws) each having an enlarged head element 24 and a threaded shank 26. The head element 24 remains on the back side of the frame 12 while the threaded shank 26 passes through one of a plurality of fastener holes 28 formed in the vertical and horizontal supports 18, 20, and into the back face 42 of the background 14. Although not shown, a plurality of complimentary receiving holes may be formed in the back face 42 of the background 14 to receive the shank 26 as it is driven into the background 14. In this fashion, once the fasteners 22 are fully seated within the background 14, the background 14 is securely attached to the frame 12.

The structure engagement component of the frame 12 includes any means or mechanism capable of securing the frame 12 to a display structure (e.g. wall, signpost, rooftop, shelf/ledge, etc.), including but not limited to superior flanges 30, inferior flanges 32, lateral flanges 34, and/or engagement apertures 36. By way of example, the superior flanges 30 extend generally perpendicularly in a forward direction from the superior ends of the vertical supports 18 and are configured to engage one or more hanging elements (e.g. hooks, chains, ropes, etc.) to enable hanging of the sign 10 from an overhead structure (e.g. ceiling, signpost, etc.). The superior flanges 30 extend in a forward direction to ensure that the sign 10 hangs in a straight vertical orientation.

The inferior flanges 32 extend generally perpendicularly in both the forward and backward directions from the inferior ends of the vertical supports 18, and are configured to provide a stable support for the sign 10 when positioned on a horizontally oriented structure such as a shelf, ledge, tabletop, etc. The inferior flanges 32 may be molded or adjusted to extend at non-perpendicular angles in the forward and/or backward directions, for example to enable positioning on an angled surface such as a slanted rooftop.

The lateral flanges 34 extend generally perpendicularly in a forward direction from the lateral ends of the horizontal supports 20 and may be configured to engage one or more hanging elements (e.g. hooks, chains, ropes, etc.) to enable hanging of the sign 10 from an overhead structure (e.g. ceiling, signpost, etc.) and/or one or more vertical support elements (e.g. sign posts) to enable secure positioning of the sign 10 between multiple vertical support elements. Although not shown in the Figures, any of the flanges 30, 32, 34 may be further equipped with additional structure to enable attachments to the various display structures, including but not limited to loops, through-holes, etc.

The engagement apertures 36 are formed within a crossbeam 38 extending between at least two vertical supports 18. The engagement apertures 36 are sized and configured to receive fasteners therethrough that fasten the frame 12 to a vertically-oriented structure, for example such as a wall or signpost. The crossbeam 38 may also serve as an attachment point for a back-mounted power supply 39, which may be in the form of a battery unit or a circuit hub with an external A/C plug extending therefrom to be plugged into a wall outlet (for example).

The background 14 is attached to the front of the frame 12 and includes a front face 40, a back face 42, and at least one elongated recess 44 (or “channel”) formed in the front face 40. The at least one elongated recess 44 is sized and configured to securely receive at least a portion of an LED light tube 16 therein. The number of elongated recesses 44 formed in the background 14 corresponds to the number of LED light tubes 16 that are needed for the design of the lighted sign 10. In the instant example shown in FIGS. 1-3, the lighted sign 10 is represented as an “OPEN” sign, in which the background 14 includes four letter-shaped sections (one for each of the O, P, E, and N) and a pair of curved sections that are arranged to form a broken oval shape around the letter-shaped sections. In this example, the background 14 includes seven distinct elongated recesses 44, with one recess 44 forming the “O”, one forming the “P”, two recesses 44 forming the “E”, one recess 44 forming the “N”, and one recess 44 for each of the peripheral broken oval sections. It should be noted that the path of the recesses 44 determine the positioning of the LED light tubes 16, and thus the recesses 44 are formed with precision into the background 14 to produce the desired lighted sign 10.

According to preferred embodiment, the background 14 and/or recesses 44 may be formed using laser cutting and/or computer numerical control (CNC) routing. This produces a greater ability for precision, which in turn allows the sign shape to be cut closer to the recesses 44/light tubes 16, as can be see by way of example with the open spaces 45 in the sign shown in FIG. 1. These open spaces 45 minimize the bulk of the background 14 around the light tubes 16, giving the lighted sign 10 a skeletal simulation of a true neon sign. Attaching the skeletal background 14 to the metal frame 12 with the back-mounted power supply 39 completes the overall look and feel of a vintage neon sign.

Preferred embodiments for the width and height of the recesses 44 depend upon with diameter of the light tubes 16 to be used. For lighted signs 10 intended for indoor use, the light tubes 16 tend to be smaller in diameter than those used in outdoor signs. With respect to indoor signs, for light tubes 16 that are 4 mm in diameter, the preferred dimensions of recesses 44 range from 2 mm to 6 mm in width, and 4 mm to 8 mm in height, with a particularly preferred embodiment calling for widths around 4 mm and heights around 6 mm. For light tubes 16 that are 6 mm in diameter, the preferred dimensions of recesses 44 range from 4 mm to 8 mm in width, and 6 mm to 10 mm in height, with a particularly preferred embodiment calling for widths around 6 mm and heights around 8 mm. For light tubes 16 that are 8 mm in diameter, the preferred dimensions of recesses 44 range from 6 mm to 10 mm in width, and 8 mm to 11 mm in height, with a particularly preferred embodiment calling for widths around 8 mm and heights around 11 mm. For light tubes 16 that are 10 mm in diameter, the preferred dimensions of recesses 44 range from 8 mm to 12 mm in width, and 10 mm to 14 mm in height, with a particularly preferred embodiment calling for widths around 10 mm and heights around 12 mm.

With respect to lighted signs 10 intended for outdoor use, most manufacturers use light tubes 16 that are larger in diameter (and better protected against the elements), and thus the size dimensions of the recesses 44 would be adjusted accordingly. For example, for light tubes 16 that are 15 mm in diameter, a preferred embodiment calls for recesses 44 that are approximately 14 mm to 18 mm in width and 16 mm-20 mm in height.

The background 14 may have any shape desired, however in most cases the shape of the background 14 will be roughly the shape of the desired end product. The background 12 may be created through molding, routing, or any other process that includes formation of one or more recesses 44 therein. The background 14 can be manufactured from any moldable or routable substance, including but not limited to metal, plastic, polyvinyl chloride (PVC) and/or wood. According to a preferred embodiment, a lighted sign 10 intended for indoor use may have a background 14 made from PVC sheets (e.g. Sintra®), while a lighted sign 10 intended for outdoor use may have a background 14 made from a more durable substance such as metal or plastic.

Each flexible LED light tube 16 is sized and configured for insertion into a specific recess 44, and then attached to a power source (not shown). Because the LED light tubes 16 are flexible, it is only necessary to provide them with the correct length dimensions to fit into each recess 44. At each end of the flexible LED light tubes 16 is an end cap 46, which serves to physically and electronically insulate the light tube 16 as well as provide a cosmetically attractive “end” to the light tube 16.

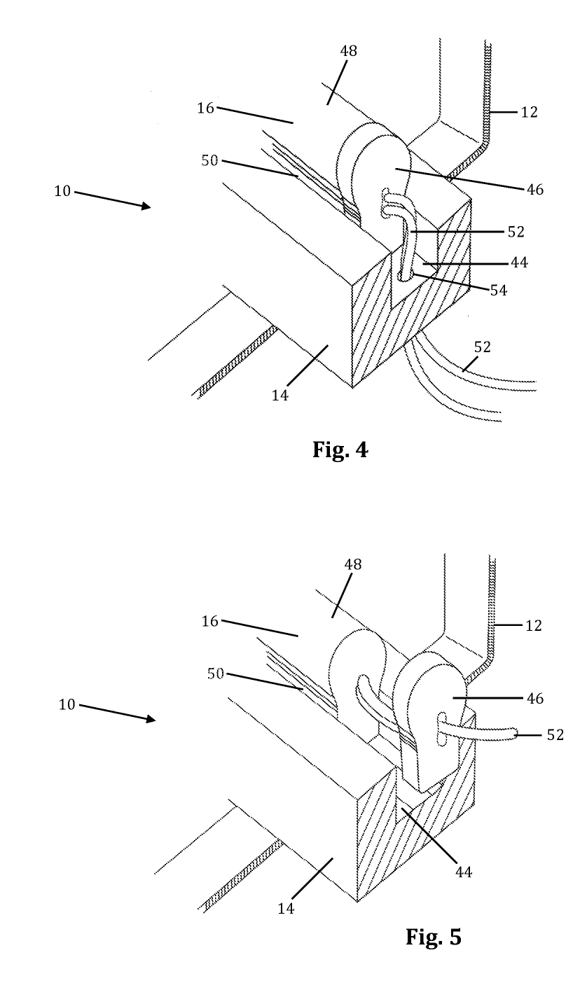

FIGS. 4-8 are perspective, cross-sectional views of several examples of the terminal ends of the LED light tubes 16, each illustrating one or more features that may be included independently or in combination with other features disclosed herein (even if not described within the context of the same embodiment).

FIG. 4 illustrates a portion of an example of the lighted sign 10 according to one embodiment, illustrating in particular the relative positioning of the LED light tube 16, background 14, and frame 12. By way of example, the LED light tube 16 includes a generally bulbous head portion 48 and a neck portion 50 extending from the bulbous head portion 48. The neck portion 50 is sized and configured to nest within the recess 44 of the background 14. The bulbous head portion 48 protrudes away from the front face 40 of the background 14 and provides a rounded exterior that mimics a neon light tube. An end cap 46 is positioned at the end of the LED light tube 16, and in this embodiment comprises (by way of example) a heat shrink closure that seals the end of the LED light tube 16 and provides an exit for wires 52, which are connected to a timer or power source (not shown). In this embodiment, the wires 52 may pass through holes 54 formed within the recess 44 to exit on the back side of the background 14.

FIG. 5 illustrates a portion of an example of the lighted sign 10 according to another embodiment, illustrating in particular the relative positioning of the LED light tube 16, background 14, and frame 12. By way of example, the LED light tube 16 includes a generally bulbous head portion 48 and a neck portion 50 extending from the bulbous head portion 48. The neck portion 50 is sized and configured to nest within the recess 44 of the background 14. The bulbous head portion 48 protrudes away from the front face 40 of the background 14 and provides a rounded exterior that mimics a neon light tube. A formed end cap 46 is positioned at the end of the LED light tube 16 that seals the end of the LED light tube 16 and provides an exit for wires 52, which are connected to a timer or power source (not shown). The formed end cap 46 provides the same seal as the heat shrunk end cap previously described but without the need for heat-shrinking.

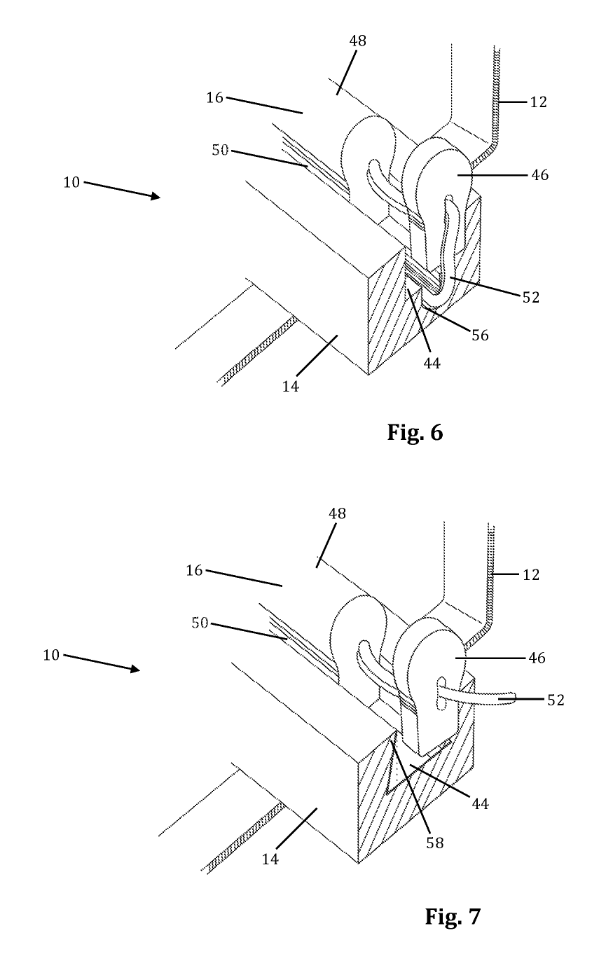

FIG. 6 illustrates a portion of an example of the lighted sign 10 according to another embodiment, illustrating in particular the relative positioning of the LED light tube 16, background 14, and frame 12. By way of example, the LED light tube 16 includes a generally bulbous head portion 48 and a neck portion 50 extending from the bulbous head portion 48. The neck portion 50 is sized and configured to nest within the recess 44 of the background 14. The bulbous head portion 48 protrudes away from the front face 40 of the background 14 and provides a rounded exterior that mimics a neon light tube. A formed end cap 46 is positioned at the end of the LED light tube 16 that seals the end of the LED light tube 16 and provides an exit for wires 52, which are connected to a timer or power source (not shown). In this embodiment, a secondary recess 56 is formed in the background 14, and more specifically within the floor of the recess 44. The secondary recess 56 has a narrower width than the width of the recess 44, and is sized and configured to receive the wires 52 therein. This allows the wires 52 to be directed to a gathering point in a more visually appealing manner (e.g. unseen), where they will then extend from the background 14 to a timer and/or power source.

FIG. 7 illustrates a portion of an example of the lighted sign 10 according to another embodiment, illustrating in particular the relative positioning of the LED light tube 16, background 14, and frame 12. By way of example, the LED light tube 16 includes a generally bulbous head portion 48 and a neck portion 50 extending from the bulbous head portion 48. The neck portion 50 is sized and configured to nest within the recess 44 of the background 14. The bulbous head portion 48 protrudes away from the front face 40 of the background 14 and provides a rounded exterior that mimics a neon light tube. A formed end cap 46 is positioned at the end of the LED light tube 16 that seals the end of the LED light tube 16 and provides an exit for wires 52, which are connected to a timer or power source (not shown). In this embodiment, the recess includes a continuous dovetail cut 58 which allows the recess 44 to more securely “grip” the neck 50 of the LED light tubes 16.

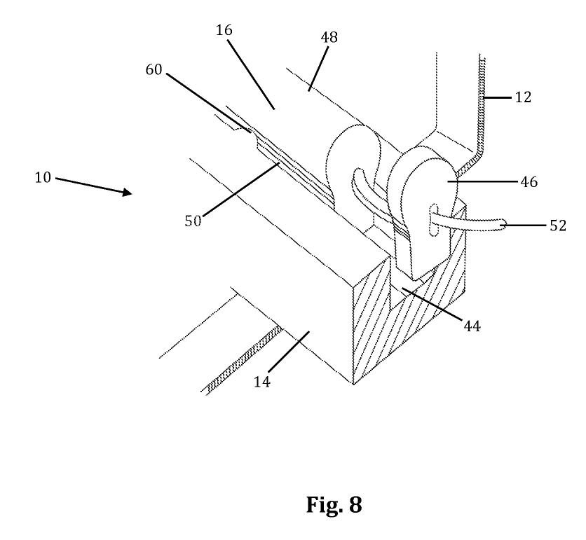

FIG. 8 illustrates a portion of an example of the lighted sign 10 according to another embodiment, illustrating in particular the relative positioning of the LED light tube 16, background 14, and frame 12. By way of example, the LED light tube 16 includes a generally bulbous head portion 48 and a neck portion 50 extending from the bulbous head portion 48. The neck portion 50 is sized and configured to nest within the recess 44 of the background 14. The bulbous head portion 48 protrudes away from the front face 40 of the background 14 and provides a rounded exterior that mimics a neon light tube. A formed end cap 46 is positioned at the end of the LED light tube 16 that seals the end of the LED light tube 16 and provides an exit for wires 52, which are connected to a timer or power source (not shown). In this embodiment, the recess includes a dovetail cut/protrusion 60 positioned intermittently along the recess 44 (e.g. at intervals of 3-5 inches) which allow the recess 44 to more securely “grip” the neck 50 of the LED light tubes 16. This intermittent protrusion embodiment achieves the same result of increased security of the LED light tube 16 without having to machine the dovetail groove along the entire length of each recess 44.

Although shown and described herein as having a background 14 that is a single piece of uniform construction, it should be understood that the background 14 may be provided in several portions that are then attached to one another (e.g. after transit to an install location) such that the recesses 44 align and one light tube 16 (or a combination of several light tubes 16) can be nested within the recesses 44 across different portions of the background 14. The different sections are attachable to one another by way of any suitable attachment mechanism, for example including but not limited to screws, nuts and bolts, magnets, hook and loop fasteners, snap fit, or have male and female parts of a “jigsaw puzzle” that could be used to attach them together. Making the sign 10 in smaller individual components that are later assembled may be advantageous in that it would be easier to ship and stand less chance of a background breaking during transit because of the smaller size.

It should be understood that while preferred embodiments are described in some detail herein, the present disclosure is made by way of example only and that variations and changes thereto are possible without departing from the subject matter coming within the scope of the following claims, and a reasonable equivalency thereof.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What is claimed is:

1. A lighted sign assembly configured to mimic the look of a classic neon sign and operable to display a message, comprising:
a background structure having a front front-facing surface, a rear-facing surface, and at least one elongated recess having a width dimension and a height dimension formed in the front-facing surface in the shape of a pattern, the pattern comprising the message to be displayed by the sign;
at least one flexible light tube having a width dimension complimentary to the width dimension of the elongated recess such that at least a portion of the flexible light tube is sized and configured to nest within the elongated recess, the flexible light tube being maneuverable so as to conform to the shape of the pattern, the flexible light tube being operable to illuminate the message displayed by the sign; and
a frame assembly including a first component configured to secure the background structure to the frame assembly and a second component configured to secure the frame assembly to a display structure.

2. The lighted sign assembly of claim 1, wherein the at least one recess is formed through at least one of a molding process and a routing process.

3. The lighted sign assembly of claim 1, wherein the background comprises at least one of metal and plastic material.

4. The lighted sign of claim 3, wherein the plastic material comprises polyvinyl chloride sheets.

5. The lighted sign of claim 1, wherein the flexible light tube comprises a light-emitting diode tube.

6. The lighted sign of claim 5, wherein the flexible light tube comprises a first end having a first end cap positioned thereon to seal the first end, and a second end having a second end cap positioned thereon to seal the second end.

7. The lighted sign of claim 6, wherein at least one of the first and second end caps comprises a heat shrink tube end.

8. The lighted sign of claim 1, wherein the elongated recess has a dovetail shaped cross-section.

9. The lighted sign of claim 1, wherein the elongated recess has a plurality of protrusions extending laterally into the recess to enact friction on the flexible light tube.

10. The lighted sign of claim 1, wherein the elongated recess comprises a floor and opposing sidewalls, and the floor further comprises a secondary recess formed therein, the secondary recess sized and configured to receive electrical wires therein, the electrical wires functioning to connect the at least one flexible light tube to a power source.

11. A modular lighted sign assembly configured to mimic the look of a classic neon sign and operable to display a message, comprising:
a modular background structure comprising at least two distinct background units that are joinable to form a single contiguous background structure, each background unit having a front-facing surface, a rear-facing surface, and at least one elongated recess having a width dimension and a height dimension formed in the front-facing surface in the shape of a pattern, the pattern comprising a portion of the message to be displayed by the sign;
at least one flexible light tube having a width dimension complimentary to the width dimension of the elongated recess such that at least a portion of the flexible light tube is sized and configured to nest within the elongated recess, the flexible light tube being maneuverable so as to conform to the shape of the pattern, the flexible light tube being operable to illuminate the message displayed by the sign; and
a frame assembly including a first component configured to secure the background structure to the frame assembly and a second component configured to secure the frame assembly to a display structure;
wherein upon joining the at least two distinct background units to form a single continuous background structure, the at least one recess of each distinct unit aligns with one another to form the complete message to be displayed by the sign.

12. The modular lighted sign assembly of claim 11, wherein the at least one recess is formed through at least one of a molding process and a routing process.

13. The modular lighted sign assembly of claim 11, wherein the background comprises at least one of metal and plastic material.

14. The modular lighted sign of claim 13, wherein the plastic material comprises polyvinyl chloride sheets.

15. The modular lighted sign of claim 11, wherein the flexible light tube comprises a light-emitting diode tube.

16. The modular lighted sign of claim 15, wherein the flexible light tube comprises a first end having a first end cap positioned thereon to seal the first end, and a second end having a second end cap positioned thereon to seal the second end.

17. The modular lighted sign of claim 16, wherein at least one of the first and second end caps comprises a heat shrink tube end.

18. The modular lighted sign of claim 11, wherein the elongated recess has a dovetail shaped cross-section.

19. The modular lighted sign of claim 11, wherein the elongated recess has a plurality of protrusions extending laterally into the recess to enact friction on the flexible light tube.

20. The modular lighted sign of claim 11, wherein the elongated recess comprises a floor and opposing sidewalls, and the floor further comprises a secondary recess formed therein, the secondary recess sized and configured to receive electrical wires therein, the electrical wires functioning to connect the at least one flexible light tube to a power source.
